(19) United States
(12) Patent Application Publication
(10) Pub. No.: US 2025/0016601 A1
(43) Pub. Date: Jan. 9, 2025

(54) SYSTEMS AND METHODS FOR DEVICE-TO-DEVICE COMMUNICATIONS

(71) Applicant: ZTE Corporation, Shenzhen, Guangdong (CN)

(72) Inventors: Yong YU, Shenzhen (CN); Weiqiang DU, Shenzhen (CN)

(73) Assignee: ZTE Corporation, Shenzhen, Guangdong (CN)

(21) Appl. No.: 18/890,213

(22) Filed: Sep. 19, 2024

Related U.S. Application Data
(63) Continuation of application No. PCT/CN2022/101223, filed on Jun. 24, 2022.

(51) Int. Cl. H04W 28/02; H04W 92/18

(52) U.S. Cl. CPC H04W 28/0205; H04W 28/0215; H04W 92/18

(57) ABSTRACT

The present disclosure relates to managing communications between a first wireless communication device and a second communication device, including receiving, by the second wireless communication device from the first wireless communication device, Quality of Service (QOS) related information. The QoS related information is received by the first wireless communication device from a network. The second wireless communication device receives from the network at least one configuration.

### CROSS-REFERENCE TO RELATED APPLICATION

This application claims the benefit of priority under 35 U.S.C. § 120 as a continuation of PCT Patent Application No. PCT/CN2022/101223, filed on Jun. 24, 2022, the disclosure of which is incorporated herein by reference in its entirety.

### TECHNICAL FIELD

The disclosure relates generally to wireless communications and, more particularly, to power management in device-to-device communications.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications, which include transmitting data to a BS (e.g., uplink transmissions) and receiving data from a BS (e.g., downlink transmissions). In SL communications, data is transmitted directly from a source UE to a target UE through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, wireless communication methods for managing communications between a first wireless communication device and a second communication device includes receiving, by the second wireless communication device from the first wireless communication device, Quality of Service (QOS) related information, where the QoS related information is received by the first wireless communication device from a network, and receiving, by the second wireless communication device from the network, at least one configuration.

In some arrangements, wireless communication methods for managing communications between a first wireless communication device and a second communication device includes receiving, by the second wireless communication device from a network, Radio Link Control (RLC) channel configuration, the RLC channel configuration includes at least one of QoS information or an RLC channel identifier (ID) identifying an RLC channel received by the second wireless communication device from the first wireless communication device. The second wireless communication device reports to the network at least one of the RLC channel ID or an RLC channel mode.

In some arrangements, wireless communication methods for managing communications between a first wireless communication device and a second communication device includes receiving, by the first wireless communication device from the second wireless communication device, at least one of carrier switch duration, carrier activation duration, and carrier deactivation duration, and refraining, by the first wireless communication device, from sending data to the second wireless communication device during at least one of the carrier switch duration, the carrier activation duration, the carrier deactivation duration, or a duration when a timer is running.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a flow diagram illustrating an example method for managing SL communications, according to various arrangements.

FIG. 4 is a flow diagram illustrating an example method for managing SL communications, according to various arrangements.

FIG. 5A is a flow diagram illustrating an example method for managing SL communications, according to various arrangements.

FIG. 5B is a flow diagram illustrating an example method for managing SL communications, according to various arrangements.

FIG. 5C is a flow diagram illustrating an example method for managing SL communications, according to various arrangements.

FIG. 5D is a flow diagram illustrating an example method for managing SL communications, according to various arrangements.

FIG. 6A is a flow diagram illustrating an example method for managing SL communications, according to various arrangements.

FIG. 6B is a flow diagram illustrating an example method for managing SL communications, according to various arrangements.

FIG. 6C is a flow diagram illustrating an example method for managing SL communications, according to various arrangements.

FIG. 7A is a flow diagram illustrating an example method for managing SL communications, according to various arrangements.

FIG. 7B is a flow diagram illustrating an example method for managing SL communications, according to various arrangements.

FIG. 7C is a flow diagram illustrating an example method for managing SL communications, according to various arrangements.

FIG. 7D is a flow diagram illustrating an example method for managing SL communications, according to various arrangements.

FIG. 8 is a flow diagram illustrating an example method for managing SL communications, according to various arrangements.

FIG. 9 is a flow diagram illustrating an example method for managing SL communications, according to various arrangements.

FIG. 10 is a flow diagram illustrating an example method for managing SL communications, according to various arrangements.

FIG. 11 is a flow diagram illustrating an example method for managing SL communications, according to various arrangements.

FIG. 12 is a flow diagram illustrating an example method for managing SL communications, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional BS-centric cellular networks have limited high data rate capabilities and support for proximity services. In this context, device-to-device (D2D) communications emerge to address the shortcomings of the BS-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSc), unilateral/sidechain/SL communication, and so on.

In the current SL technical solutions, a UE monitoring a measurement resource pool may lead to significant power consumption. Presently, in order to improve the coverage of the UE, the UE accesses the network through a relay UE. The arrangements of the present disclosure allow a UE to conserve energy in an SL system. For example, the network can configure a remote UE when the remote UE accesses the network through a relay UE.

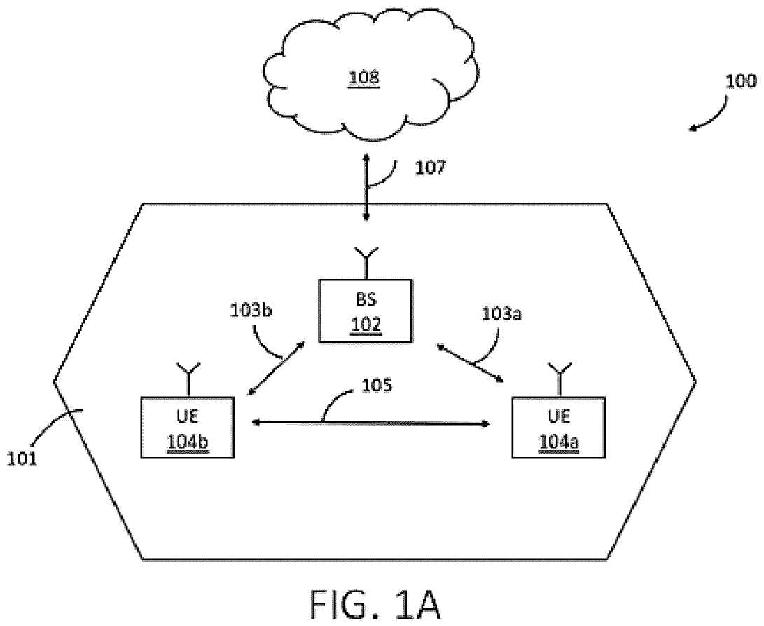

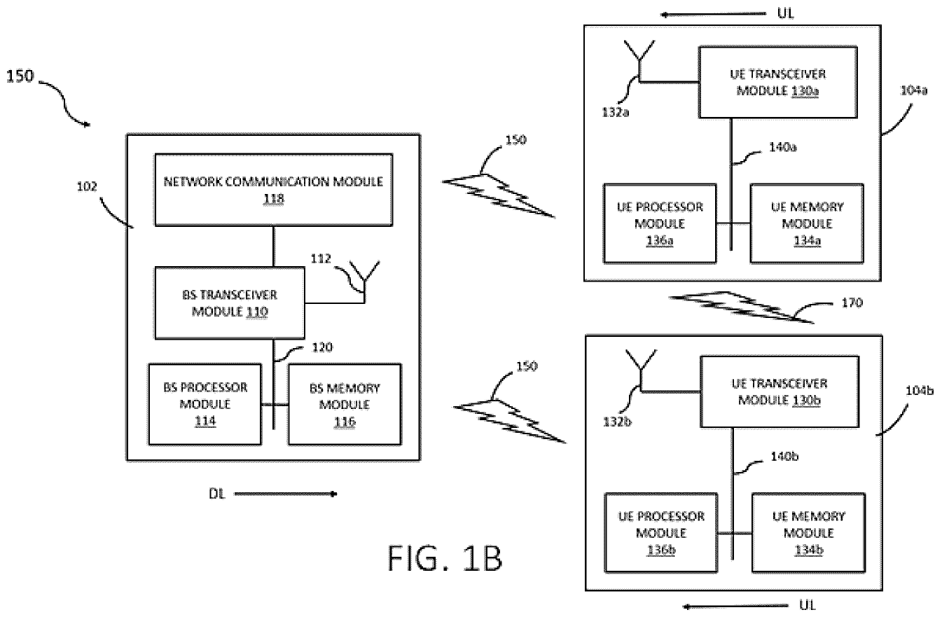

Referring to FIG. 1A, an example wireless communication network 100 is shown. The wireless communication network 100 illustrates a group communication within a cellular network. In a wireless communication system, a network side communication node or a BS can include a next Generation Node B (gNB), an E-UTRAN Node B (also known as Evolved Node B, cNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a BS 102 and UEs 104a and 104b, respectively. In some arrangements, the BS 102 and UEs 104a/104b are sometimes referred to as “wireless communication node” and “wireless communication device,” respectively. Such communication nodes/devices can perform wireless communications.

In the illustrated arrangement of FIG. 1A, the BS 102 can define a cell 101 in which the UEs 104a and 104b are located. The UEs 104a and/or 104b can be moving or remain stationary within a coverage of the cell 101. The UE 104a can communicate with the BS 102 via a communication channel 103a. Similarly, the UE 104b can communicate with the BS 102 via a communication channel 103b. In addition, the UEs 104a and 104b can communicate with each other via a communication channel 105. The communication channels 103a and 104b between a respective UE and the BS can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The BS 102 is connected to Core Network (CN) 108 through an external interface 107, e.g., an Iu interface.

In some examples, a remote UE (e.g., the UE 104b) that does not directly communicate with the BS 102 or the CN 108 (e.g., the communication channel link 103b is not established) communicates indirectly with the BS 102 and the CN 108 using the SL communication channel 105 via a relay UE (e.g., the UE 104a), which can directly communicate with the BS 102 and the CN 108 or indirectly communicate with the BS 102 and the CN 108 via another relay UE that can directly communicate with the BS 102 and the CN 108.

FIG. 1B illustrates a block diagram of an example wireless communication system 150 for transmitting and receiving downlink, uplink and SL communication signals, in accordance with some arrangements of the present disclosure. In some arrangements, the system 150 can transmit and receive data in a wireless communication environment such as the wireless communication network 100 of FIG. 1A, as described above.

The system 150 generally includes the BS 102 and UEs 104a and 104b, as described in FIG. 1A. The BS 102 includes a BS transceiver module 110, a BS antenna 112, a BS memory module 116, a BS processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The BS 102 communicates with the UEs 104a and 104b via one or more of a communication channel 150, which can be any wireless channel or other medium known in the art suitable for transmission of data as described herein.

The system 150 may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the BS 102 is known as an uplink transmission, and a wireless transmission from an antenna of the BS 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the BS transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the BS transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

In some arrangements, each of the UEs 104a and 104b can operate in a hybrid communication network in which the UE communicates with the BS 102, and with other UEs, e.g., between 104a and 104b. As described in further detail below, the UEs 104a and 104b support SL communications with other UE's as well as downlink/uplink communications between the BS 102 and the UEs 104a and 104b. In general, the SL communication allows the UEs 104a and 104b to establish a direct communication link with each other, or with other UEs from different cells, without requiring the BS 102 to relay data between UEs.

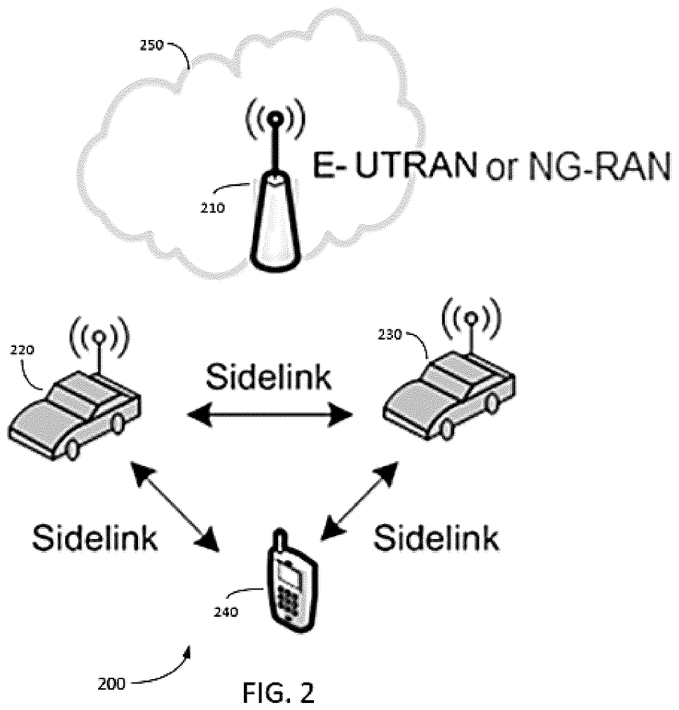

FIG. 2 is a diagram illustrating an example system 200 for SL communication, according to various arrangements. As shown in FIG. 2, a BS 210 (such as BS 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

In current SL communication systems and in regard to the TX UE transmitting data to RX UE, the BS sends to TX UE's TX-side configurations, including the TX-side Radio Bearer (RB) channel configuration, to the RX UE. The TX UE sends the RX-side configurations, including the RX-side RB channel configuration, to the RX UE. In case the Radio Link Control (RLC) channel is a bi-directional RLC channel, the RX UE needs to report this RLC channel's mode and corresponding Quality of Service (QOS) profile to the BS to obtain the corresponding RX-side TX RLC channel configuration. The QoS profile that is associated to this RLC channel can be derived from the Service Data Adaption Protocol (SDAP) configuration.

With regard to SL relay, the BS sends the RLC channel configuration, e.g., Backhaul (BH) PC5 RLC channel configuration, to the remote UE and the relay UE. The relay UE sends the remote UE's RX-side BH PC5 RLC channel configuration to the remote UE. For SL relay, only BH PC5 RLC channel is configured to relay UE. The relay UE does not have SDAP configuration and does not send the SDAP configuration to the remote UE. In case the RLC channel is a bi-directional RLC channel, remote UE lacks information on the manner in which associated QoS profile of this bi-directional RLC channel is sent to the BS.

Additionally, in order for L2-relay UE to differentiate between Sidelink Relay Adaptation Protocol (SRAP) data Protocol Data Unit (PDU) for Signaling RB (SRB) and Data RB (DRB) if the identifier of the bearer (BEARER ID) is 0/1/2/3, for a SRAP Data PDU received from PC5 (or Uu) via sl-Egress-RLC-Channel-Uu (or via sl-Egress-RLC-Channel-PC5), L2-relay UE can distinguish an SRB from a DRB based on the associated sl-RemoteUE-RB-Identity.

In some arrangements, the relay UE sends the QoS information received from the BS to the RX UE (e.g., the remote UE). In an SL relay scenario, the RX UE (e.g., the remote UE) lacks the knowledge of the QoS information of each of at least one RLC channel (e.g., each PC5 BH PC5 RLC channel) between the RX UE and the TX UE, where the at least one RLC channel is the channel through which the RX UE and the TX UE communicate data, signaling, and/or information. The TX UE (e.g., the relay UE) sends the QoS information of each of at least one RLC channel received from the BS to the RX UE (e.g., the remote UE). In the implementations in which the network functions are split between Centralized Unit (CU) and Distributed Unit (DU) and the QoS information is included in RLC channel configuration (e.g., PC5 RLC channel configuration), the CU sends the QoS information of each of the at least one RLC channel to the DU. The DU and the CU can be provided in the same BS in some arrangements. In other arrangements, the DU and the CU can be provided in different BSs.

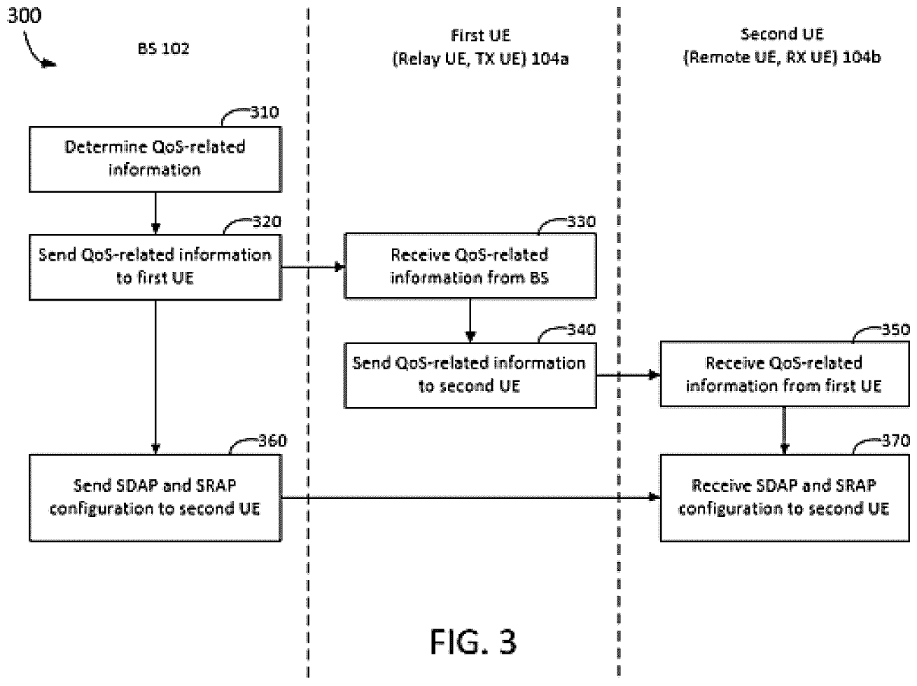

In that regard, FIG. 3 is a flow diagram illustrating an example method 300 for managing SL communications, according to various arrangements. Referring to FIG. 3, the method 300 can be performed by the BS 102, a first UE (e.g., the relay UE, the TX UE, or the UE 104a), and a second UE (e.g., the remote UE, the RX UE, or the UE 104b). In this example, the second UE is remote to the BS and can receive data from or send data to the BS indirectly, via the first UE.

At 310, the BS (also referred to as a network including one or more BSs) determines the QoS-related information. In the examples in which the network functions are split between CU and DU, determining the QoS-related information includes the CU sending QoS-related information to the DU. The QoS-related information includes at least one of QoS information, the at least one RLC channel (e.g., the PC5 RLC channel) for which the QoS information applies, or the at least one RB (e.g., the PC5 RB) for which the QoS information applies.

At 320, the BS sends the QoS-related information to the first UE. The first UE receives the QoS-related information from the BS at 330. At 340 the first UE sends the QoS-related information to the second UE. At 350, the second UE receives the QoS-related information from the first UE.

In some examples, each of the at least one channel (e.g., each PC5 RLC channel) can be identified by at least one of a channel ID (e.g., a PC5 RLC channel ID), a channel index (e.g., a PC5 RLC channel index), and so on. In some examples, the QoS information includes at least one of a QOS Flow Identifier (QFI), a PDU session ID, a PC5 QFI, a Uu QFI, a QoS profile, a Uu QoS profile, a PC5 QoS profile, and so on. The QFI identifies a QoS flow. The PDU session ID identifies a PDU session. The PC5 QFI identifies a QoS flow that is based on the PC5 interface. The Uu QFI identifies a QoS flow that is based on the Uu interface.

In some arrangements, at 360, the network (e.g., the BS 102) sends at least one configuration (e.g., the SDAP configuration and SRAP configuration) to the second UE. At 370, the second UE receives from the BS 102 the SDAP configuration and the SRAP configuration. The SDAP configuration contains a mapping of QFIs and corresponding RBs. The SRAP configuration contains the mapping of the RBs of the RX UE (e.g., the remote UE) and the at least one channel (e.g., the PC5 RLC channel).

In some arrangements, for the RX UE (e.g., the remote UE), the QFI received from the TX UE (e.g., the relay UE) is the QFI in the SDAP configuration received from the BS. In this case, in response to the RX UE (e.g., the remote UE) receiving a bi-direction PC5 RLC channel configuration and corresponding QoS information, the RX UE can combine the SDAP configuration, the SRAP configuration, and the QoS information received from the TX UE (e.g., the relay UE) to determine the bi-direction at least one RLC channel (e.g., the PC5 RLC channel) that is associated to each RB of the RX UE (e.g., the remote UE).

In some arrangements, the RX UE (e.g., the remote UE) reports at least one of an RLC mode, the QoS information, or a channel ID of the at least one RLC channel (e.g., the PC5 RLC channel ID) to the BS.

In some arrangements, the RX UE (e.g., the remote UE) may determine that an RLC channel ID (e.g., the PC5 RLC channel ID) received from the TX UE (e.g., the relay UE) and an RLC channel ID received from the BS identifies the same RLC channel. The TX UE (e.g., the relay UE) can set the PC5 RLC channel ID in PC5 signaling to a same value of PC5 RLC channel ID in Uu signaling for the same PC5 RLC channel configuration.

In some arrangements, the RX UE (e.g., the remote UE) reports at least one of following information to the network (e.g., the BS) for indicating a PC5 RLC channel mode: a PC5 RLC channel ID received from Uu signaling, PC5 RLC channel ID received from PC5 signaling, or a PC5 RLC mode such as Acknowledge Mode (AM), Un-Acknowledge Mode (UM), Transparent mode (TM), or so on.

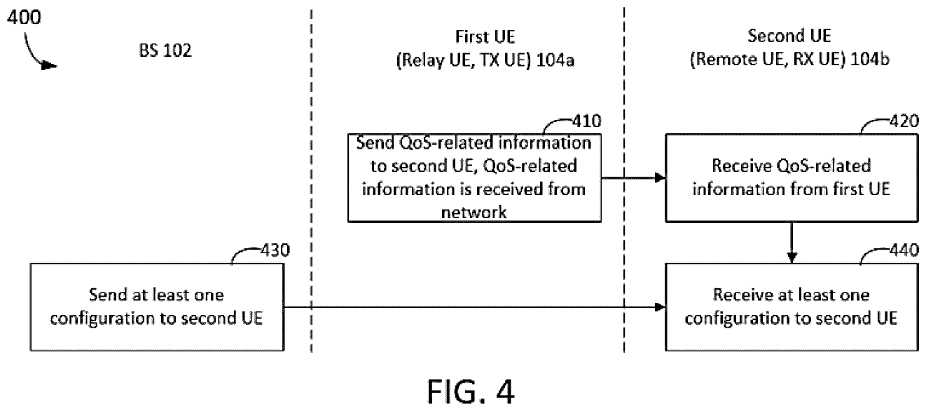

FIG. 4 is a flow diagram illustrating an example method for managing SL communications, according to various arrangements. Referring to FIG. 4, the method 400 can be performed by the BS 102, a first UE (e.g., the relay UE, the TX UE, or the UE 104a), and a second UE (e.g., the remote UE, the RX UE, or the UE 104b). In this example, the second UE is remote to the BS and can receive data from or send data to the BS indirectly, via the first UE.

At 410, the first UE sends to the second UE QoS-related information, which the second UE receives at 420. The QoS related information is received by the first UE from a network (e.g., the BS). At 430, the network (e.g., the BS) sends to the second UE at least one configuration, which the second UE receives at 440.

In some arrangements, the QoS-related information includes at least one of QoS information, at least one RLC channel for which the QoS information applies, or at least one RB for which the QoS information applies. In some arrangements, the QoS information includes at least one of a QFI, a PDU ID, a PC5 QFI, a Uu QFI, a QoS profile, a Uu QoS profile, or a PC5 QoS profile. In some arrangements, each of the at least one RLC channel is identified by at least one of a channel ID or a channel index.

In some arrangements, the least one configuration includes at least one of a first configuration (e.g., SDAP configuration) including a mapping of at least one QFI to at least one RB and a second configuration (e.g., SRAP configuration) including a mapping of the at least one RB to at least one RLC channel. In some arrangements, the QoS related information received from the first UE includes a QFI that is the same as one of the at least one QFI in the first configuration. The second UE determines an RLC channel associated with each RB of the second UE based on the first configuration, the second configuration, and the QoS related information. In some arrangements, the second UE sends to the network, at least one of an RLC mode, the QoS information, or a channel ID of the at least one RLC channel.

In some arrangements, the QoS-related information includes a first RLC channel ID. The at least one configuration includes a second RLC channel ID. The first RLC channel ID and the second RLC channel ID identify a same RLC channel. The first UE identifies the RLC channel in a first signaling (e.g., PC5 signaling) and a second signaling (e.g., Uu signaling) for a same RLC channel configuration.

In some arrangements, reporting, by the second UE to the network, a Radio Link Control (RLC) mode identified by at least one of an RLC channel identifier (ID) received from a first signaling (e.g., PC5 signaling), an RLC channel ID received from a second signaling, or an RLC mode.

In some examples, for RLC mode indication, the RX UE use PC5 QFI to identify each RLC channel. After receiving PC5 SDAP configuration and PC5 RB configuration including RLC channel, the RX UE (e.g., the remote UE) can determine which RLC channel configuration received from the BS is to be applied for reported RLC channel. However, for the remote UE, given that the SDAP configuration received from the BS is Uu SDAP configuration that contains Uu QFI, after reporting the PC5 RLC channel mode indication, the remote UE cannot identify which PC5 RLC channel configuration received from the BS belongs to the reported PC5 RLC channel. In this case, the remote UE can use a self-assigned PC5 RLC channel ID to identify the reported PC5 RLC channel mode. Alternatively, the PC5 RLC channel configuration received from the BS includes the PC5 QFI reported by the remote UE.

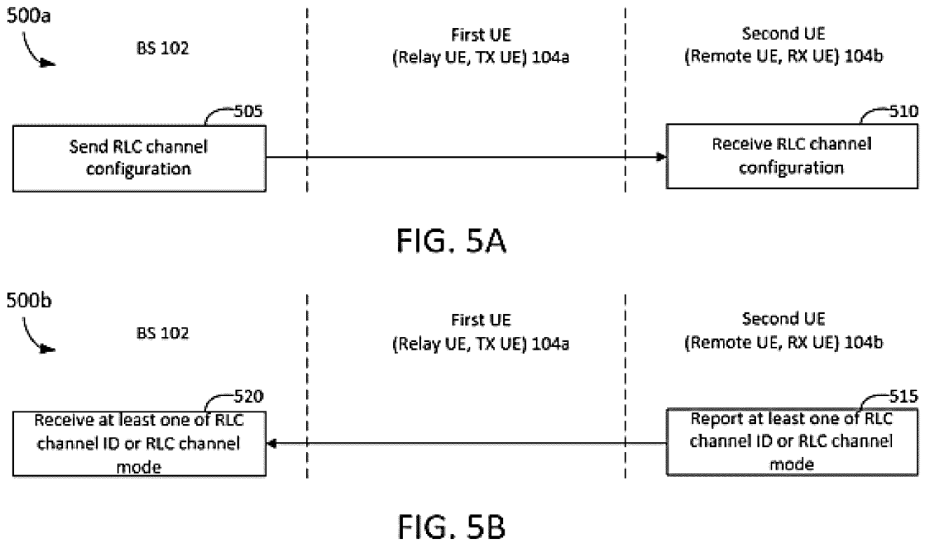

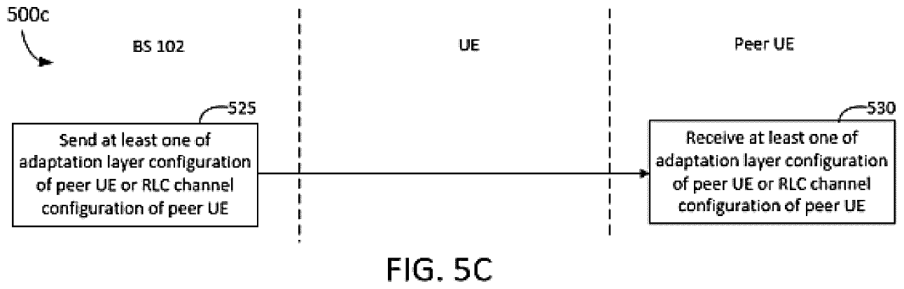

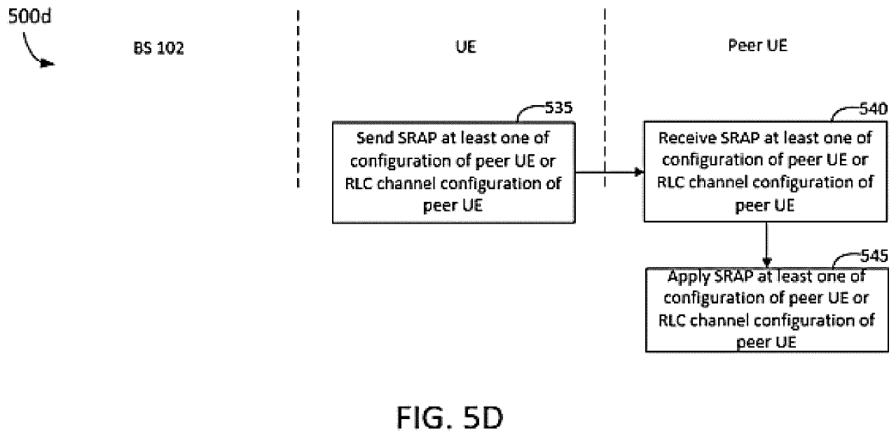

FIG. 5A is a flow diagram illustrating an example method 500a for managing SL communications, according to various arrangements. Referring to FIG. 5A, the method 500a can be performed by the BS 102, a first UE (e.g., the relay UE, the TX UE, or the UE 104a), and a second UE (e.g., the remote UE, the RX UE, or the UE 104b).

In some arrangements, at 505, the network (e.g., the BS) sends the RLC channel configuration (e.g., PC5 RLC channel configuration) to the second UE. The second UE (e.g., the RX UE or the remote UE) receives the RLC channel configuration from the BS at 510. In some examples, the RLC channel configuration includes at least one of the QoS information or an RLC channel ID (e.g., PC5 RLC channel ID) identifying the PC5 RLC channel received from first UE (e.g., the TX UE or the relay UE).

FIG. 5B is a flow diagram illustrating an example method 500b for managing SL communications, according to various arrangements. Referring to FIG. 5B, the method 500b can be performed by the BS 102, a first UE (e.g., the relay UE, the TX UE, or the UE 104a), and a second UE (e.g., the remote UE, the RX UE, or the UE 104b).

In some arrangements, at 515, the second UE (e.g., the RX UE or the remote UE) reports at least one of following information to the network (e.g., the BS): a RLC channel ID (e.g., a PC5 RLC channel ID) identifying an RLC channel (e.g., the PC5 RLC channel) received from the first UE (e.g., the TX UE, the relay UE) or an RLC channel mode (e.g., the PC5 RLC channel mode). At 520, the BS receives the information containing at least one of the RLC channel ID or the RLC channel mode.

FIG. 5C is a flow diagram illustrating an example method 500c for managing SL communications, according to various arrangements. Referring to FIG. 5C, the method 500c can be performed by the BS 102, a UE, and a peer UE. In some arrangements, the UE can be one of a relay UE or a remote UE. In some arrangements, the peer UE can be the other one of the relay UE or the remote UE. In some arrangements, at 525, the network (e.g., the BS) sends to the UE at least one of an adaptation layer configuration of a peer UE, RLC channel configuration (e.g., PC5 RLC channel configuration) of a peer UE, or so on. At 530, the UE receives from the BS the at least one of an adaptation layer configuration of the peer UE, RLC channel configuration (e.g., PC5 RLC channel configuration) of the peer UE, or so on.

FIG. 5D is a flow diagram illustrating an example method 500d for managing SL communications, according to various arrangements. Referring to FIG. 5D, the method 500d can be performed by the BS 102, a UE, and a peer UE. In some arrangements, the UE can be one of a relay UE or a remote UE. In some arrangements, the peer UE can be the other one of the relay UE or the remote UE. In some arrangements, at 535, the UE sends to the peer UE at least one of SRAP configuration of the peer UE, RLC channel configuration (e.g., the PC5 RLC channel configuration) of the peer UE, or so on. In some arrangements, the peer UE (or a UE), after receiving at least one of the SRAP configuration or the PC5 RLC channel configuration from the UE (or a peer UE), applies at least one of the SRAP or PC5 RLC channel configuration, at 545.

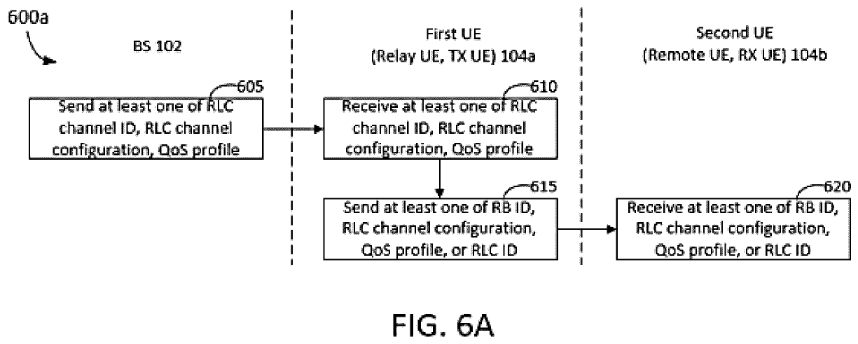

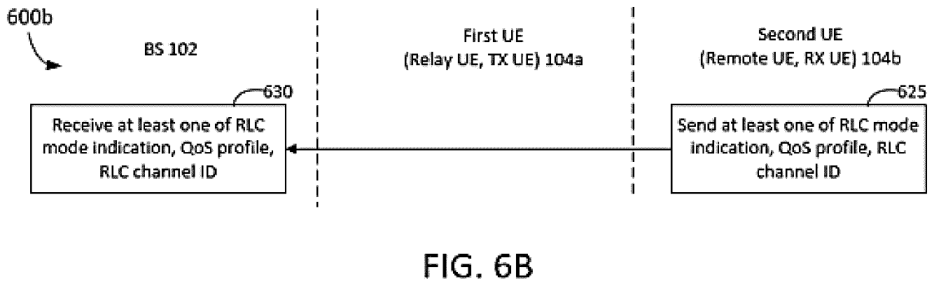

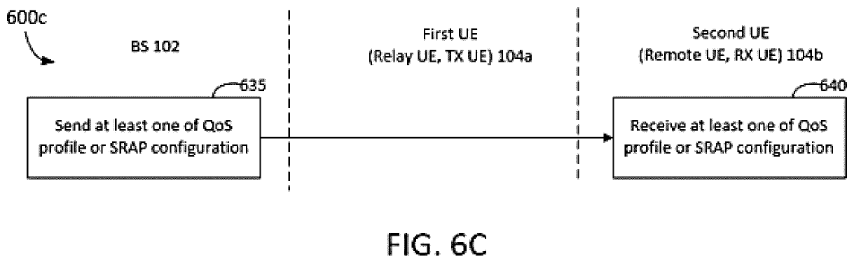

FIG. 6A is a flow diagram illustrating an example method 600a for managing SL communications, according to various arrangements. Referring to FIG. 6A, the method 600a can be performed by the BS 102, a first UE (e.g., the relay UE, the TX UE, or the UE 104a), and a second UE (e.g., the remote UE, the RX UE, or the UE 104b).

In some arrangements, at 605, the network (e.g., the BS) sends to the first UE at least one of an RLC channel ID (e.g., SL RLC bearer configuration index, PC5 RLC channel ID, or so on), RLC channel configuration (e.g., TX side RLC channel configuration), QoS profile (e.g., PC5 QoS profile or Uu QoS profile), which the first UE receives at 610. The QoS profile includes at least one of a QFI, Packet Flow Identity (PFI), 5G QOS Identifier (5QI), PC5 5QI, QOS parameters, or so on.

In some arrangements, at 615, the first UE sends to the second UE at least one of an RB ID (e.g., SL RB PC5 configuration index), RLC channel configuration, QoS profile (e.g., a PC5 QoS profile or Uu QoS profile), or RLC ID (e.g., SL RLC bearer configuration index, PC5 RLC channel ID, or Logical Channel ID (LCID)), which the second UE receives at 620. The QoS profile includes at least one of QFI, PFI, 5QI, PC5 5QI, QOS parameters, or so on.

FIG. 6B is a flow diagram illustrating an example method 600b for managing SL communications, according to various arrangements. Referring to FIG. 6B, the method 600b can be performed by the BS 102, a first UE (e.g., the relay UE, the TX UE, or the UE 104a), and a second UE (e.g., the remote UE, the RX UE, or the UE 104b).

In some arrangements, at 625, the second UE sends to the BS at least one of an RLC mode indication, QoS profile (e.g., a PC5 QoS profile or Uu QoS profile), RB ID (e.g., SL RB PC5 configuration index), RLC channel ID, or so on. The QoS profile includes QFI, PFI, 5QI, PC5 5QI, or so on, which the BS receives at 630. The RLC channel ID includes SL RLC bearer configuration index, LCID, PC5 RLC channel ID. The RLC channel ID can be allocated by the remote UE itself (e.g., self-assigned) or received from the peer UE. The RLC channel ID is used to uniquely identify the reported RLC channel. In some arrangements, the QoS flow ID in QoS profile is not used to uniquely identify one SL QoS flow, and is instead used to identify one remote UE's Uu QoS flow.

FIG. 6C is a flow diagram illustrating an example method 600c for managing SL communications, according to various arrangements. Referring to FIG. 6C, the method 600c can be performed by the BS 102, a first UE (e.g., the relay UE, the TX UE, or the UE 104a), and a second UE (e.g., the remote UE, the RX UE, or the UE 104b).

In some arrangements, at 635, the BS sends to second UE at least one of a QoS profile (e.g., PC5 QoS profile or Uu QoS profile) or SRAP configuration. The QoS profile can include at least one of QFI, PFI, 5QI, PC5 5QI, or so on. The SRAP configuration includes an egress RLC channel ID that is allocated by second UE itself (self-assigned). Examples of the egress RLC channel ID include SL RLC bearer configuration index, PC5 RLC channel ID, and so on.

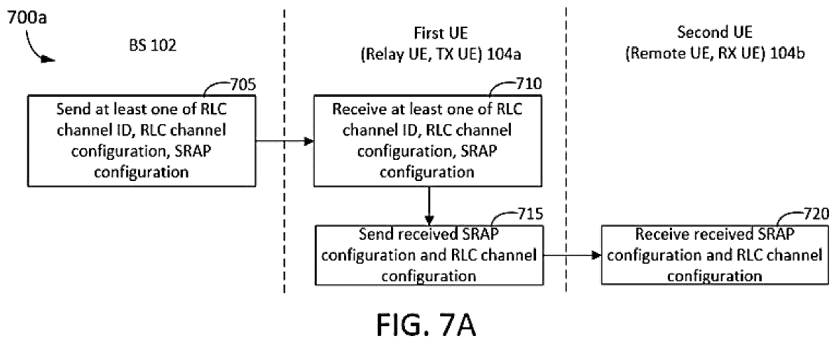

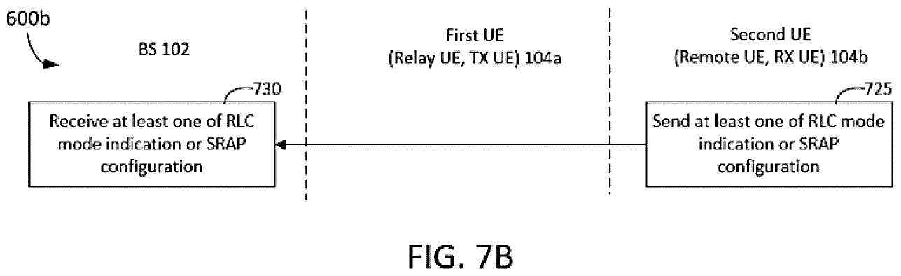

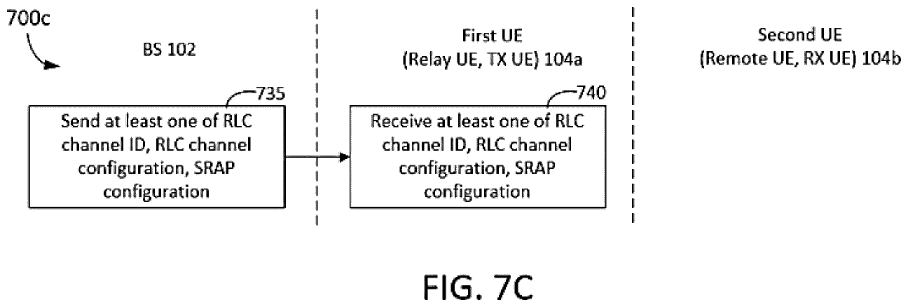

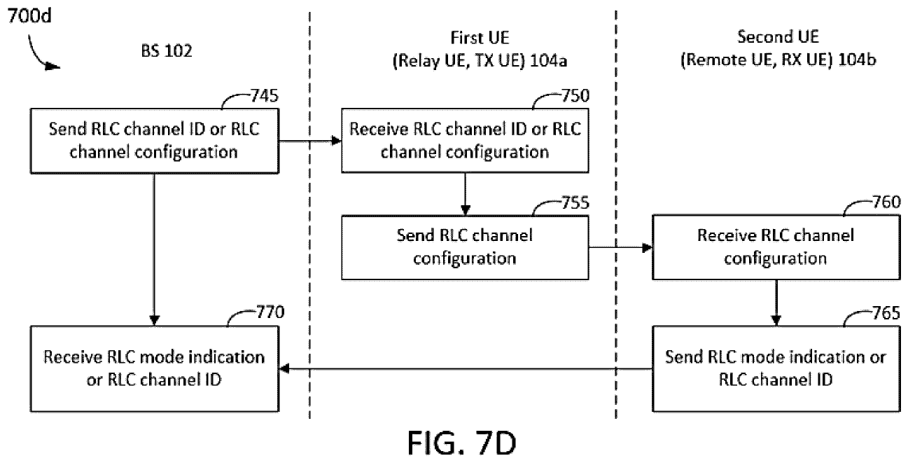

FIG. 7A is a flow diagram illustrating an example method 700a for managing SL communications, according to various arrangements. Referring to FIG. 7A, the method 700a can be performed by the BS 102, a first UE (e.g., the relay UE, the TX UE, or the UE 104a), and a second UE (e.g., the remote UE, the RX UE, or the UE 104b). In some arrangements, at 705, the BS sends to the first UE at least one of RLC channel ID (e.g., SL RLC bearer configuration index or PC5 RLC channel ID), RLC channel configuration (e.g., TX side RLC channel configuration), SRAP configuration (including RB ID, egress RLC channel ID), or so on, which the first UE receives at 710. At 715, the first UE sends the received SRAP configuration along with RLC channel configuration to second UE, which the second UE receives at 720.

FIG. 7B is a flow diagram illustrating an example method 700b for managing SL communications, according to various arrangements. Referring to FIG. 7B, the method 700b can be performed by the BS 102, a first UE (e.g., the relay UE, the TX UE, or the UE 104a), and a second UE (e.g., the remote UE, the RX UE, or the UE 104b). At 725, the second UE sends to the BS at least one of an RLC mode indication or the SRAP configuration (including at least one of RB ID, egress RLC channel ID, or DL SRAP configuration), which the BS receives at 730. The SRAP configuration sent by the remote UE to the BS can be the remote UE's DL SRAP configuration in relay UE.

FIG. 7C is a flow diagram illustrating an example method 700c for managing SL communications, according to various arrangements. Referring to FIG. 7C, the method 700c can be performed by the BS 102, a first UE (e.g., the relay UE, the TX UE, or the UE 104a), and a second UE (e.g., the remote UE, the RX UE, or the UE 104b).

In some arrangements, at 735, the BS sends to the first UE at least one of an RLC channel ID (e.g., SL RLC bearer configuration index, PC5 RLC channel ID, and so on), RLC channel configuration (e.g., TX side RLC channel configuration, remote UE's TX side RLC channel configuration, or so on), or SRAP configuration (including RB ID, egress RLC channel ID, DL SRAP configuration, UL SRAP configuration, or so on), which the first UE receives at 740. The SRAP configuration can be the UL SRAP configuration in the second UE. In this case, the second UE applies the received SRAP configuration for uplink traffic. The RLC channel configuration can be the second UE's TX side RLC channel configuration. In this case, the second UE applies the received RLC channel configuration for uplink traffic.

FIG. 7D is a flow diagram illustrating an example method 700d for managing SL communications, according to various arrangements. Referring to FIG. 7D, the method 700d can be performed by the BS 102, a first UE (e.g., the relay UE, the TX UE, or the UE 104a), and a second UE (e.g., the remote UE, the RX UE, or the UE 104b).

In some arrangements, at 745, the BS sends to the first UE at least one of an RLC channel ID (e.g., SL RLC bearer configuration index, PC5 RLC channel ID, and so on) or RLC channel configuration (e.g., TX side RLC channel configuration, remote UE's TX side RLC channel configuration, or so on), which the first UE receives at 750. The first UE sends the received RLC channel configuration to the second UE at 755, which the second UE receives at 760. At 765, the second UE sends to the BS at least one of RLC mode indication or RLC channel ID (e.g., SL RLC bearer configuration index or PC5 RLC channel ID), which the BS receives at 770. In such arrangements, the RLC channel ID sent from the relay UE to the remote UE is not allocated by the remote UE itself. The relay UE sends the received RLC channel ID to remote UE.

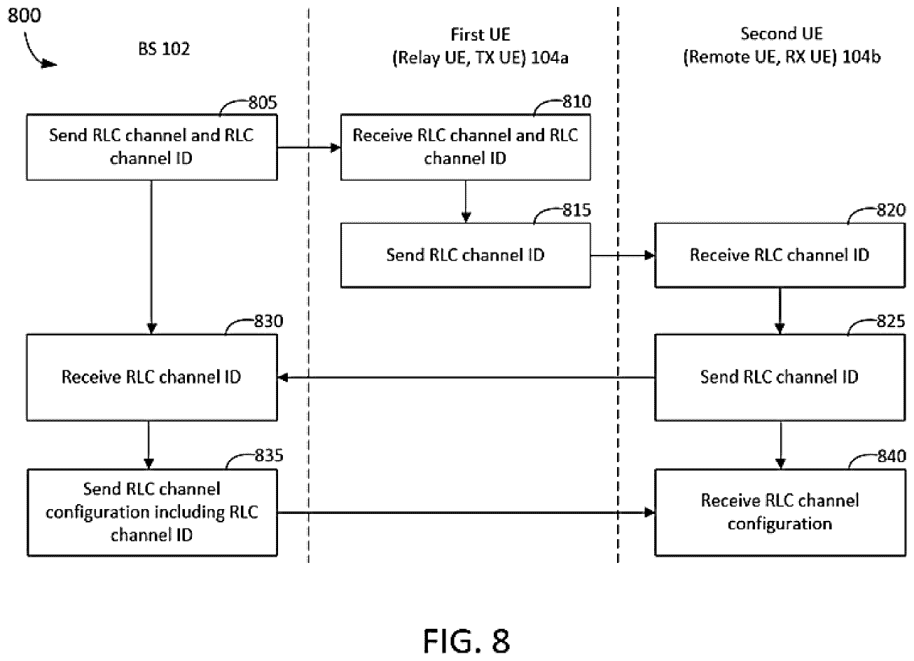

FIG. 8 is a flow diagram illustrating an example method 800 for managing SL communications, according to various arrangements. Referring to FIG. 8, the method 800 can be performed by the BS 102, a first UE (e.g., the relay UE, the TX UE, or the UE 104a), and a second UE (e.g., the remote UE, the RX UE, or the UE 104b).

In some arrangements, at 805, the BS sends the RLC channel (e.g., the PC5 RLC channel) and the RLC channel ID (e.g., the PC5 RLC channel ID) to the first UE, which the first UE receives at 810. At 815, the first UE sends the RLC channel ID to the second UE, which the second UE receives at 820. At 825, the second UE reports the received RLC channel ID to the BS, which the BS receives at 830. In some examples, the second UE relays the UE ID to BS. At 835, the BS sends to the second UE the RLC channel configuration including at least one of RLC channel ID (e.g., PC5 RLC channel ID) or the received RLC channel ID (e.g., the received PC5 RLC channel ID) used to identify this RLC channel configuration belongs to which RLC channel with RX configuration received from relay UE. The second UE receives at 840 the RLC channel configuration including the RLC channel ID.

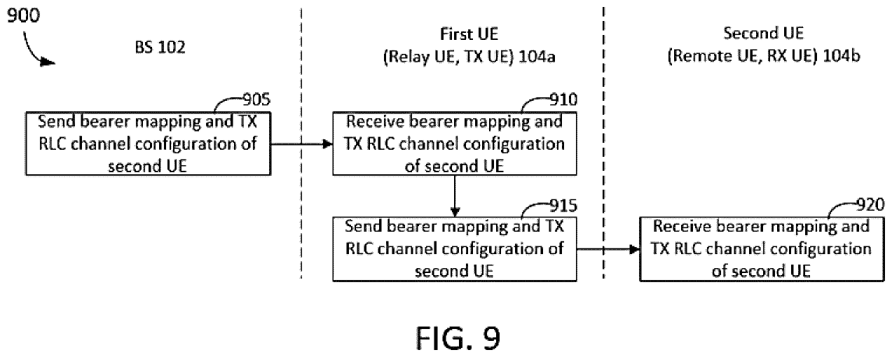

FIG. 9 is a flow diagram illustrating an example method 900 for managing SL communications, according to various arrangements. Referring to FIG. 9, the method 900 can be performed by the BS 102, a first UE (e.g., the relay UE, the TX UE, or the UE 104a), and a second UE (e.g., the remote UE, the RX UE, or the UE 104b). In some arrangements, at 905, the BS sends the bearer mapping and TX RLC channel configuration (e.g., TX PC5 RLC channel configuration) of the second UE to the first UE, which the first UE receives at 910. At 915, the first UE sends the bearer mapping and TX RLC channel configuration to the second UE, which the second UE receives at 920.

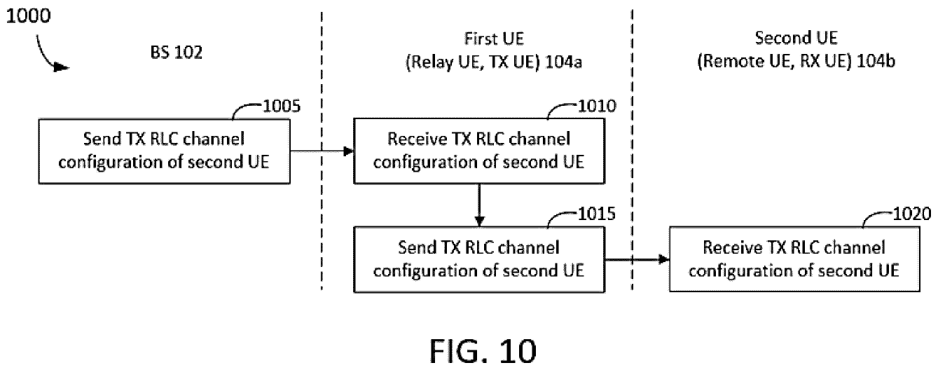

FIG. 10 is a flow diagram illustrating an example method 1000 for managing SL communications, according to various arrangements. Referring to FIG. 10, the method 1000 can be performed by the BS 102, a first UE (e.g., the relay UE, the TX UE, or the UE 104a), and a second UE (e.g., the remote UE, the RX UE, or the UE 104b). In some arrangements, at 1005, the BS sends TX RLC channel configuration (e.g., TX PC5 RLC channel configuration) of the second UE to the first UE, which the first UE receives at 1010. At 1015, the first UE sends the TX RLC channel configuration to the second UE, which the second UE receives at 1020. For uplink, the bearer mapping for the second UE does not use this TX RLC channel configuration.

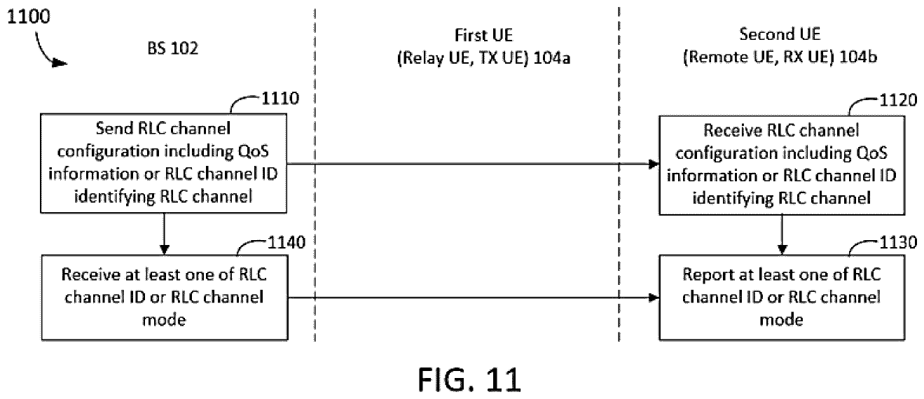

FIG. 11 is a flow diagram illustrating an example method 1100 for managing SL communications, according to various arrangements. Referring to FIG. 11, the method 1100 can be performed by the BS 102, a first UE (e.g., the relay UE, the TX UE, or the UE 104a), and a second UE (e.g., the remote UE, the RX UE, or the UE 104b).

At 1110, the network (e.g., the BS) sends RLC channel configuration to the second UE, which the second UE receives at 1110. The RLC channel configuration includes at least one of QoS information or an RLC channel ID identifying an RLC channel received by the second UE from the first UE. In some examples, the second UE reports to the network at least one of the RLC channel ID or an RLC channel mode at 1130, which the network receives at 1140.

In some arrangements, the second UE receives from the network at least one of an adaptation layer configuration of the first UE or an RLC channel configuration of the first UE. The second UE sends to the first UE, at least one of a SRAP configuration of the first UE or the RLC channel configuration of the first UE.

In some arrangements, the second UE receives from the first UE, at least one of RB ID, RLC channel configuration, QoS profile, or RLC ID. In some arrangements, the second UE sends to the network, at least one of an RLC mode indication, QoS profile, RB ID, RLC channel ID. In some arrangements, the second UE receives from the network, at least one of a QoS profile or SRAP configuration.

In some arrangements, the second UE receives from the first UE, RLC channel configuration and first SRAP configuration received by the first UE from the network. The second UE sends to the network at least one of an RLC mode indication or second SRAP configuration. The second SRAP configuration is a downlink SRAP configuration.

In some arrangements, the second UE applies SRAP configuration and the RLC channel configuration in uplink traffic of the second UE. The RLC channel configuration is a transmission-side RLC channel configuration.

In some arrangements, the second UE receives from the first UE, RLC channel configuration. The second UE sends to the network at least one of an RLC mode indication or RLC channel ID.

In some arrangements, the RLC channel configuration includes the RLC channel ID used to identify that the RLC channel configuration belongs to the RLC channel with reception configuration received from the first UE.

In some arrangements, the second UE receives from the first UE, a mapping that maps at least one RB to transmission RLC channel configuration of the second UE.

In some arrangements, the second UE receives from the first UE, transmission RLC channel configuration of the second UE.

To improve the packet rate or reliability, multiple carrier communication can be implemented. With regard to SL communication, due to the limited UE capability, a UE cannot receive data from multiple carriers simultaneously. Thus, to receive the data from multiple carrier, a UE needs to switch carriers among multiple configured carriers. However, due to process delay, a UE cannot complete the carrier switching immediately, which may cause possible packet loss during switch duration. In some examples, the TX UE does not send the data to RX UE during carrier switch.

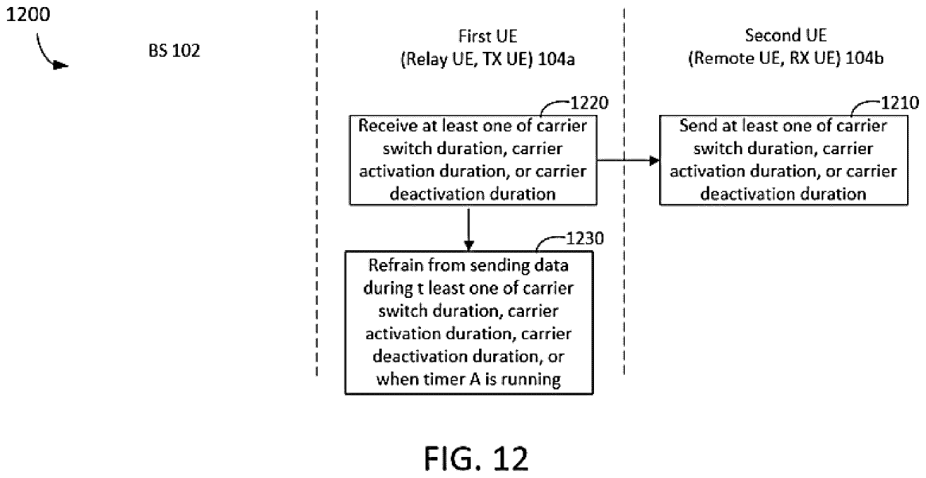

FIG. 12 is a flow diagram illustrating an example method 1200 for managing SL communications, according to various arrangements. Referring to FIG. 12, the method 1200 can be performed by the BS 102, a first UE (e.g., the relay UE, the TX UE, or the UE 104a), and a second UE (e.g., the remote UE, the RX UE, or the UE 104b). In some arrangements, at 1210, the second UE sends to the first UE at least one of a carrier switch duration, a carrier activation duration, and a carrier deactivation duration. The carrier switching duration is the duration of time in which the second UE can switch from a first carrier to a second carrier. The carrier activation duration of time in which the second UE can activate a carrier. The carrier deactivation duration of time in which the second UE can deactivate a carrier. At least one of the carrier switch duration, the carrier activation duration, and the carrier deactivation duration can be referred to as a carrier operation duration.

In some examples, the first UE refrains from sending data or does not send data during one or more of the carrier switch duration, carrier activation duration, or carrier deactivation duration. The second UE does not receive any data from the first UE during one or more of the carrier switch duration, carrier activation duration, carrier deactivation duration, or a duration when timer A is running, at 1230.

In some examples, the first UE starts the timer A in response to at least one of the first sending the carrier switch signaling to the second UE, the first UE sends the carrier activation signaling to the second UE, or the first UE sending the carrier deactivation signaling to RX UE.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for managing communications between a first wireless communication device and a second wireless communication device, comprising:
receiving, by the second wireless communication device from the first wireless communication device, Quality of Service (QOS) related information, wherein the QoS related information is received by the first wireless communication device from a network;
receiving, by the second wireless communication device from the network, at least one configuration.

2. The wireless communication method of claim 1, wherein the QoS-related information comprises at least one of:
QoS information;
at least one Radio Link Control (RLC) channel for which the QoS information applies; or
at least one Radio Bearer (RB) for which the QoS information applies.

3. The wireless communication method of claim 2, wherein the QoS information comprises at least one of a QoS Flow Identifier (QFI), a Protocol Data Unit (PDU) session identifier (ID), a PC5 QFI, a Uu QFI, a QoS profile, a Uu QoS profile, or a PC5 QoS profile.

4. The wireless communication method of claim 2, wherein each of the at least one RLC channel is identified by at least one of a channel identifier (ID) or a channel index.

5. The wireless communication method of claim 1, wherein the least one configuration comprises at least one of:
a first configuration comprising a mapping of at least one QoS Flow Identifier (QFI) to at least one Radio Bearer (RB); or
a second configuration comprising a mapping of the at least one RB to at least one Radio Link Control (RLC) channel.

6. The wireless communication method of claim 5, wherein
the QoS related information received from the first wireless communication device comprises a QFI that is the same as one of the at least one QFI in the first configuration; and
the wireless communication method further comprises determining, by the second wireless communication device, an RLC channel associated with each RB of the second wireless communication device based on the first configuration, the second configuration, and the QoS related information.

7. The wireless communication method of claim 5, further comprising sending, by the second wireless communication device to the network, at least one of an RLC mode, the QoS information, or a channel ID of the at least one RLC channel.

8. The wireless communication method of claim 1, wherein
the QoS-related information comprises a first Radio Link Control (RLC) channel identifier (ID);
the at least one configuration comprises a second RLC channel ID;
the first RLC channel ID and the second RLC channel ID identify a same RLC channel; and
the first wireless communication device identifies the RLC channel in a first signaling and a second signaling for a same RLC channel configuration.

9. The wireless communication method of claim 1, further comprising reporting, by the second wireless communication device to the network, a Radio Link Control (RLC) mode identified by at least one of an RLC channel identifier (ID) received from a first signaling, an RLC channel ID received from a second signaling, or an RLC mode.

10. A wireless communication method for managing communications between a first wireless communication device and a second communication device, comprising:
sending, by the first wireless communication device to the second wireless communication device, Quality of Service (QOS) related information, wherein the QoS related information is received by the first wireless communication device from a network,
wherein the second wireless communication device receives from the network at least one configuration.

11. A first wireless communication device, comprising:
at least one processor configured to:
send, via a transmitter to the second wireless communication device, Quality of Service (QoS) related information, wherein the QoS related information is received by the first wireless communication device from a network,
wherein the second wireless communication device receives from the network at least one configuration.

12. A second wireless communication device, comprising:
at least one processor configured to:
receive, via a receiver from the first wireless communication device, Quality of Service (QoS) related information, wherein the QoS related information is received by the first wireless communication device from a network;
receiving, via the receiver from the network, at least one configuration.

13. The second wireless communication device of claim 12, wherein the QoS-related information comprises at least one of:
QoS information;
at least one Radio Link Control (RLC) channel for which the QoS information applies; or
at least one Radio Bearer (RB) for which the QoS information applies.

14. The second wireless communication device of claim 13, wherein the QoS information comprises at least one of a QoS Flow Identifier (QFI), a Protocol Data Unit (PDU) session identifier (ID), a PC5 QFI, a Uu QFI, a QoS profile, a Uu QoS profile, or a PC5 QoS profile.

15. The second wireless communication device of claim 13, wherein each of the at least one RLC channel is identified by at least one of a channel identifier (ID) or a channel index.

16. The second wireless communication device of claim 12, wherein the least one configuration comprises at least one of:
a first configuration comprising a mapping of at least one QoS Flow Identifier (QFI) to at least one Radio Bearer (RB); or
a second configuration comprising a mapping of the at least one RB to at least one Radio Link Control (RLC) channel.

17. The second wireless communication device of claim 16, wherein
the QoS related information received from the first wireless communication device comprises a QFI that is the same as one of the at least one QFI in the first configuration; and
the wireless communication method further comprises determining, by the second wireless communication device, an RLC channel associated with each RB of the second wireless communication device based on the first configuration, the second configuration, and the QoS related information.

18. The second wireless communication device of claim 16, wherein the at least one processor is configured to send, via a transmitter to the network, at least one of an RLC mode, the QoS information, or a channel ID of the at least one RLC channel.

19. The second wireless communication device of claim 12, wherein
the QoS-related information comprises a first Radio Link Control (RLC) channel identifier (ID);
the at least one configuration comprises a second RLC channel ID;
the first RLC channel ID and the second RLC channel ID identify a same RLC channel; and
the first wireless communication device identifies the RLC channel in a first signaling and a second signaling for a same RLC channel configuration.

20. The second wireless communication device of claim 12, wherein the at least one processor is configured to report, via a transmitter to the network, a Radio Link Control (RLC) mode identified by at least one of an RLC channel identifier (ID) received from a first signaling, an RLC channel ID received from a second signaling, or an RLC mode.
